(19) United States
(12) Patent Application Publication
(10) Pub. No.: US 2012/0105784 A1
(43) Pub. Date: May 3, 2012

(54) PIXEL STRUCTURE AND DISPLAY PANEL

(75) Inventors: Sheng-Ju Ho, Hsinchu City (TW); Cheng-Han Tsao, Taipei County (TW); Chung-Yi Chiu, Tainan County (TW)

(73) Assignee: AU OPTRONICS CORPORATION, Hsinchu (TW)

(21) Appl. No.: 12/975,366

(22) Filed: Dec. 22, 2010

(30) Foreign Application Priority Data
Oct. 29, 2010 (TW) 99137270

(51) Int. Cl. G02F 1/1343

(52) U.S. Cl. 349/139

(57) ABSTRACT

A pixel structure and a display panel are provided. The pixel structure includes a first scan line, a data line, a first active device, a first pixel electrode, and a first conductive pattern. The first active device is connected to the first scan line and the data line. The first pixel electrode is electrically connected to the data line through the first active device. The first conductive pattern is located above the first scan line and connected in parallel with the first scan line.

### CROSS-REFERENCE TO RELATED APPLICATION

This application claims the priority benefit of Taiwan application serial no. 99137270, filed on Oct. 29, 2010. The entirety the above-mentioned patent application is hereby incorporated by reference herein and made a part of specification.

### BACKGROUND

1. Field of the Invention

The invention relates to a pixel structure and a display panel. Particularly, the invention relates to a pixel structure and a display panel with good signal transmission quality.

2. Description of Related Art

Rapid progress of multimedia society benefits from quick development of semiconductor components and display devices. Regarding the display devices, a liquid crystal display (LCD) has become a main stream in the market due to its advantages of high image quality, better space usage efficiency, low power consumption, no radiation, etc. Generally, the LCD includes an LCD panel and a backlight module used for providing a planar light source. The LCD panel is composed of a color filter substrate, a thin film transistor array substrate, and a liquid crystal layer between the two substrates.

The thin film transistor array substrate is mainly composed of a plurality of scan lines, a plurality of data lines and a plurality of pixel structures on the substrate. Each of the pixel structures includes a thin film transistor and a pixel electrode. The pixel electrode is connected to the thin film transistor, and the thin film transistor is connected to the scan line and the data line. The scan line is controlled to turn on/off the thin film transistor, so as to input a signal transmitted by the data line to the corresponding pixel electrode.

Generally, the pixel structures are arranged on the substrate in an array, wherein the pixel structures of a same row are connected to a same scan line, and the pixel structures of a same column are connected to a same data line. When a size of the LCD panel is increased, lengths of the scan lines and the data lines are accordingly increased. Now, impedances of the scan lines and the data lines are increased, which is of no avail for signal transmission. For example, a voltage transmitted by the scan line or the data line is liable to be decreased as the impedance increases. Therefore, the signal transmission quality of the scan lines and the data lines is an important consideration factor of the LCD panel.

### SUMMARY OF THE INVENTION

The invention is directed to a pixel structure, which can improve a signal transmission quality of scan lines.

The invention is directed to a pixel structure, which can improve a signal transmission quality of data lines.

The invention is directed to a display panel, which has an ideal signal transmission quality.

The invention provides a pixel structure including a first scan line, a data line, a first active device, a first pixel electrode, and a first conductive pattern. The first active device is connected to the first scan line and the data line. The first pixel electrode is electrically connected to the data line through the first active device. The first conductive pattern is located above the first scan line and connected in parallel with the first scan line.

The invention provides another pixel structure including a first scan line, a data line, a first active device, a first pixel electrode, and a first conductive pattern. The first active device is connected to the first scan line and the data line. The first pixel electrode is electrically connected to the data line through the first active device. The first conductive pattern is located under the data line and connected in parallel with the data line.

The invention provides a display panel including a plurality of pixel structures, an opposite substrate, a display media layer, and a patterned retarder. The pixel structures are arranged on a substrate in an array. The opposite substrate is opposite to the substrate. The display media layer is disposed between the substrate and the opposite substrate. The patterned retarder is disposed on the opposite substrate. The patterned retarder has a plurality of retardation patterns. Each of the pixel structures includes a first scan line, a second scan line, a data line, a first active device, a first pixel electrode, a first conductive pattern, a second active device, and a second pixel electrode. The first active device is connected to the first scan line and the data line. The first pixel electrode is electrically connected to the data line through the first active device. The first conductive pattern is located above the first scan line and connected in parallel with the first scan line. The second active device is electrically connected to the second scan line and the first pixel electrode. The second pixel electrode is electrically connected to the data line through the first active device. The second scan line of each of the pixel structures is electrically connected to the first scan line of the pixel structures of a next row.

According to the above descriptions, in the invention, a design of connecting dual conductive layers in parallel is used to reduce the impedance of at least one of the scan line and the data line. Therefore, the signal transmission quality of at least one of the scan line and the data line is desirable for applying in a large-size product. Even if a frame update rate is increased, an ideal display quality is still maintained and thus the pixel structures of the invention are capable of being applied in a three-dimensional display panel.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a pixel structure according to a first embodiment of the invention.

FIG. 2 is a cross-sectional view along a sectional line A-A′ of FIG. 1.

FIG. 3 is a top view of a pixel structure according to a second embodiment of the invention.

FIG. 4 is a cross-sectional view along a sectional line B-B′ of FIG. 3.

FIG. 5 is a top view of a pixel structure according to a third embodiment of the invention.

FIG. 6 is a top view of a pixel structure according to a fourth embodiment of the invention.

FIG. 7 is a top view of a pixel structure according to a fifth embodiment of the invention.

FIG. 8 is a top view of a pixel structure according to a sixth embodiment of the invention.

FIG. 9 is a cross-sectional view of a display panel according to an embodiment of the invention.

FIG. 10 is a top view of a black matrix pattern according to an embodiment of the invention, which is used in collaboration with the pixel structure of FIG. 7.

FIG. 11 is a top view of a black matrix pattern according to another embodiment of the invention, which is used in collaboration with the pixel structure of FIG. 8.

### DETAILED DESCRIPTION OF DISCLOSED EMBODIMENTS

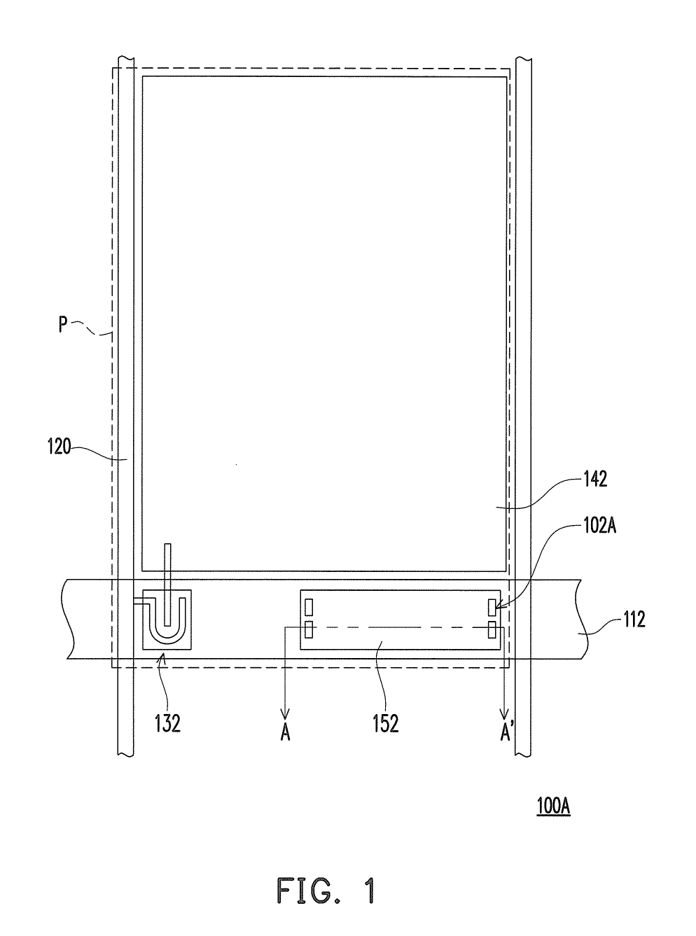

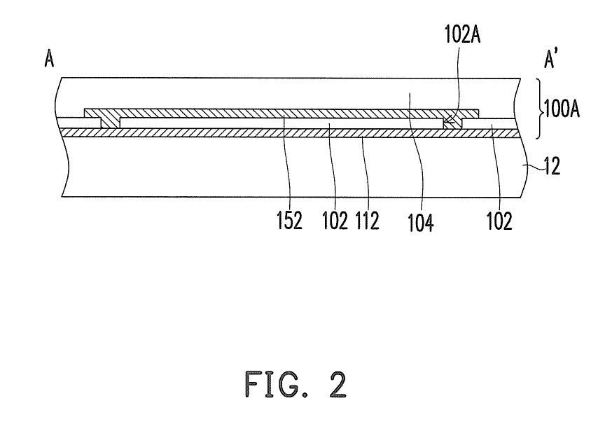

FIG. 1 is a top view of a pixel structure according to a first embodiment of the invention. FIG. 2 is a cross-sectional view along a sectional line A-A′ of FIG. 1. Referring to FIG. 1 and FIG. 2, the pixel structure 100A includes a first scan line 112, a data line 120, a first active device 132, a first pixel electrode 142 and a first conductive pattern 152. The first active device 132 is connected to the first scan line 112 and the data line 120. The first pixel electrode 142 is electrically connected to the data line 120 through the first active device 132. The first conductive pattern 152 is located above the first scan line 112 and connected in parallel with the first scan line 112.

Referring to FIG. 2, the pixel structure 100A is disposed on a substrate 12, and further includes a gate insulation layer 102 and a protection layer 104. The gate insulation layer 102 covers the first scan line 112, and the protection layer 104 covers the first conductive pattern 152, the first scan line 112, the data line 120 and the first active device 132 (only the first conductive pattern 152 and the first scan line 112 are illustrated in FIG. 2). In the present embodiment, the first conductive pattern 152 and the data line 120 are, for example, formed by a same film layer. Meanwhile, the gate insulation layer 102 has a plurality of first openings 102A, so that the first conductive pattern 152 can be connected in parallel with the first scan line 112 through the first openings 102A.

Parallel connection of the first conductive pattern 152 and the first scan line 112 avails reducing an impedance of the first scan line 112. Therefore, the first scan line 112 has an ideal signal transmission quality. Namely, in the present embodiment, a design of dual conductive layers is used to mitigate a negative influence of the impedance during signal transmission, so as to improve the signal transmission quality of the first scan line 112.

In detail, the first scan line 112 and the data line 120 encircle a pixel region P. According to the top view of FIG. 1, in the pixel region P, an area of the first conductive pattern 152 does not exceed a configuration area of the first scan line 112. Therefore, the first conductive pattern 152 is substantially completely overlapped with the first scan line 112 without influencing a display aperture ratio.

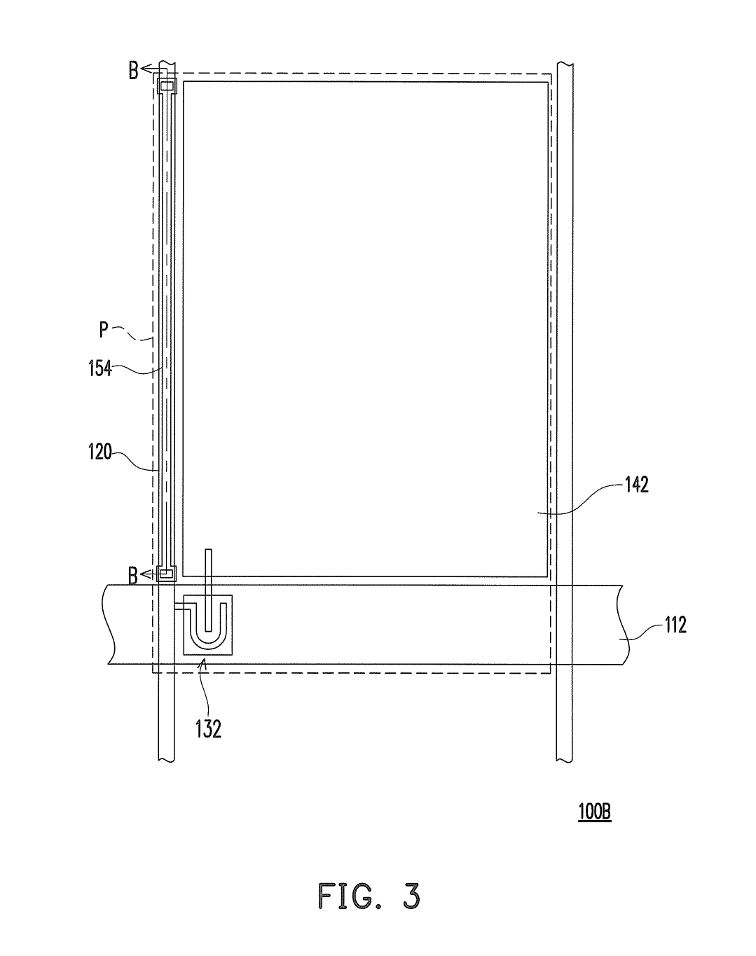

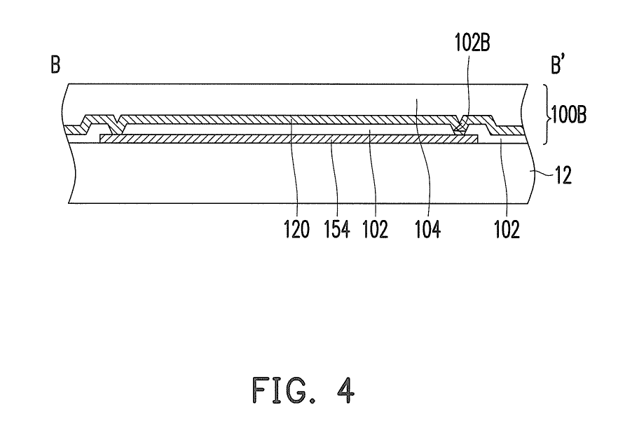

FIG. 3 is a top view of a pixel structure according to a second embodiment of the invention. FIG. 4 is a cross-sectional view along a sectional line B-B′ of FIG. 3. Referring to FIG. 3, the pixel structure 100B includes the first scan line 112, the data line 120, the first active device 132, the first pixel electrode 142 and a second conductive pattern 154. The first active device 132 is connected to the first scan line 112 and the data line 120. The first pixel electrode 142 is electrically connected to the data line 120 through the first active device 132. The second conductive pattern 154 is located under the data line 120 and connected in parallel with the data line 120.

In detail, referring to FIG. 3 and FIG. 4, the pixel structure 100B is disposed on the substrate 12, and further includes the gate insulation layer 102 and the protection layer 104. The gate insulation layer 102 covers the first scan line 112 and the second conductive pattern 154, where only the second conductive pattern 154 is illustrated in FIG. 4, while the first scan line 112 is not illustrated. Moreover, the gate insulation layer 102 has a plurality of second openings 102B, where the second openings 102B exposes the second conductive pattern 154, and the data line 120 is connected in parallel with the second conductive pattern 154 through the second openings 102B.

Parallel connection of the second conductive pattern 154 and the data line 120 avails reducing an impedance of the data line 120. Therefore, the data line 120 has an ideal signal transmission quality. Namely, in the present embodiment, a design of dual conductive layers is used to mitigate a negative influence of the impedance during signal transmission, so as to improve the signal transmission quality of the data line 120. In detail, the first scan line 112 and the data line 120 encircle a pixel region P. According to the top view of FIG. 3, in the pixel region P, an area of the second conductive pattern 154 does not exceed a configuration area of the data line 120. Therefore, the second conductive pattern 154 is substantially completely overlapped with the data line 120, and is shield by the data line 120 without influencing a display aperture ratio.

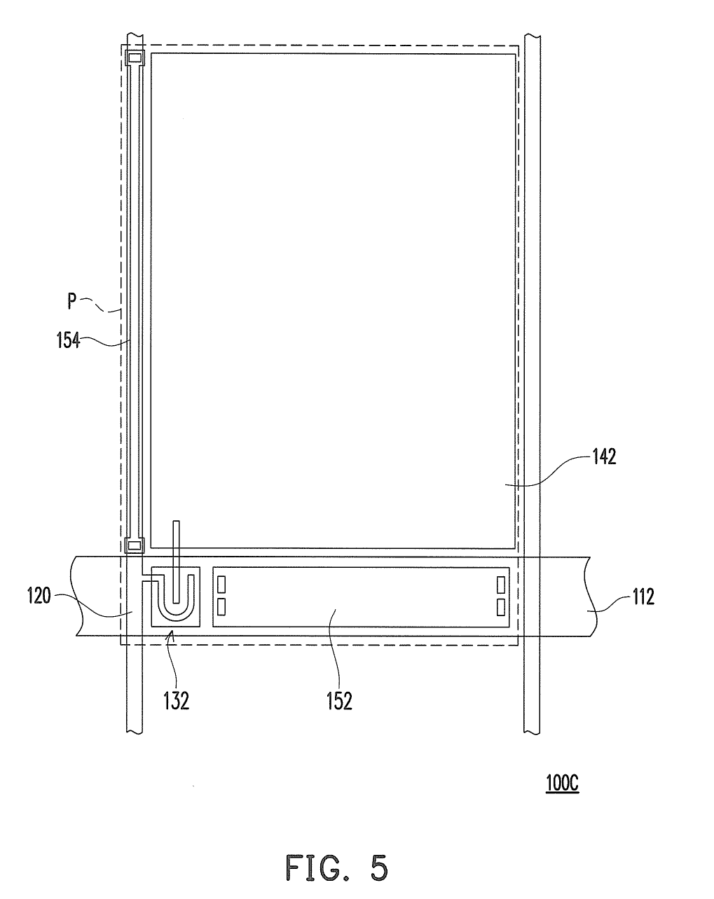

FIG. 5 is a top view of a pixel structure according to a third embodiment of the invention. Referring to FIG. 5, the pixel structure 100C includes the first scan line 112, the data line 120, the first active device 132, the first pixel electrode 142, the first conductive pattern 152 and the second conductive pattern 154. The data line 120 is intersected with the first scan line 112. The first active device 132 is connected to the first scan line 112 and the data line 120. The first pixel electrode 142 is electrically connected to the data line 120 through the first active device 132. The first conductive pattern 152 is located above the first scan line 112 and connected in parallel with the first scan line 112. The second conductive pattern 154 is located under the data line 120 and connected in parallel with the data line 120.

In brief, in the present embodiment, features of the first embodiment and the second embodiment are combined, so that both of the first scan line 112 and the data line 120 have the ideal signal transmission quality. Certainly, configurations of the first conductive pattern 152 and the second conductive pattern 154 do not influence the display aperture ratio of the pixel structure 100C since configuration areas of the first conductive pattern 152 and the second conductive pattern 154 are completely overlapped with the first scan line 112 and the data line 120, respectively, and the configuration areas of the first conductive pattern 152 and the second conductive pattern 154 can be completely shielded by the first scan line 112 and the data line 120, respectively.

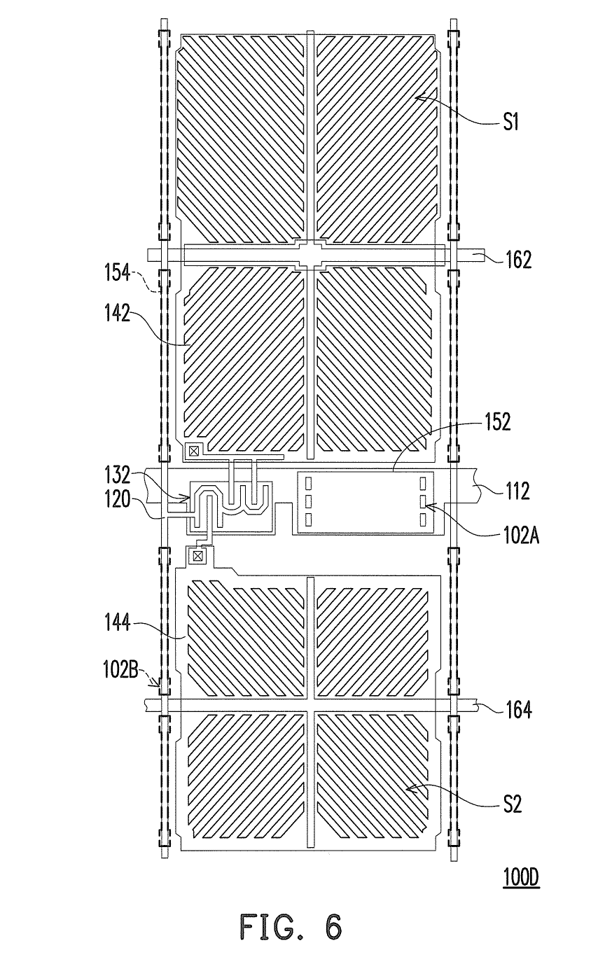

FIG. 6 is a top view of a pixel structure according to a fourth embodiment of the invention. Referring to FIG. 6, the pixel structure 100D includes the first scan line 112, the data line 120, the first active device 132, the first pixel electrode 142, a second pixel electrode 144, the first conductive pattern 152 and the second conductive pattern 154. The data line 120 is intersected with the first scan line 112. The first active device 132 is connected to the first scan line 112 and the data line 120. The first pixel electrode 142 is electrically connected to the data line 120 through the first active device 132. The second pixel electrode 144 is also electrically connected to the data line 120 through the first active device 132. The first conductive pattern 152 is located above the first scan line 112 and connected in parallel with the first scan line 112. The second conductive pattern 154 is located under the data line 120 and connected in parallel with the data line 120. In other words, a main difference between the present embodiment and the third embodiment is that the pixel structure 100D further includes the second pixel electrode 144.

In the present embodiment, the first scan line 112 is located between the first pixel electrode 142 and the second pixel electrode 144. Actually, the pixel structure 100D further includes a first capacitor electrode 162 and a second capacitor electrode 164, which are respectively located below the first pixel electrode 142 and the second pixel electrode 144. The first capacitor electrode 162 and the first pixel electrode 142 commonly form a storage capacitor to maintain a display voltage of the first pixel electrode 142. The second capacitor electrode 164 and the second pixel electrode 144 commonly form another storage capacitor to maintain a display voltage of the second pixel electrode 144. Further, the first pixel electrode 142 may selectively have a plurality of first slits S1 to define a plurality of orientation directions, and the second pixel electrode 144 also has a plurality of second slits S2 to define a plurality of orientation directions. In this way, the pixel structure 100D may have a wide viewing angle display effect.

In the present embodiment, the first device 132 is, for example, a thin film transistor of dual-drain. The first active device 132 is turned on or turned off based on the signal transmitted by the first scan line 112, and a signal transmitted by the data line 120 is selectively input to the first pixel electrode 142 and the second pixel electrode 144. The signal transmitted by the first scan line 112 determines a state of the first active device 132, and the signal transmitted by the data line 120 determines a voltage written to the first pixel electrode 142 and the second pixel electrode 144. Moreover, in the pixel structure 100D of the present embodiment, the first conductive pattern 152 is connected in parallel with the first scan line 112, and the second conductive pattern 154 is connected in parallel with the data line 120. Therefore, the design of the present embodiment may reduce transmission impedances of the first scan line 112 and the data line 120, so as to improve the signal transmission qualities of the first scan line 112 and the data line 120. In other words, in the present embodiment, the design of dual conductive layers is used to mitigate a negative influence of the impedances during signal transmission.

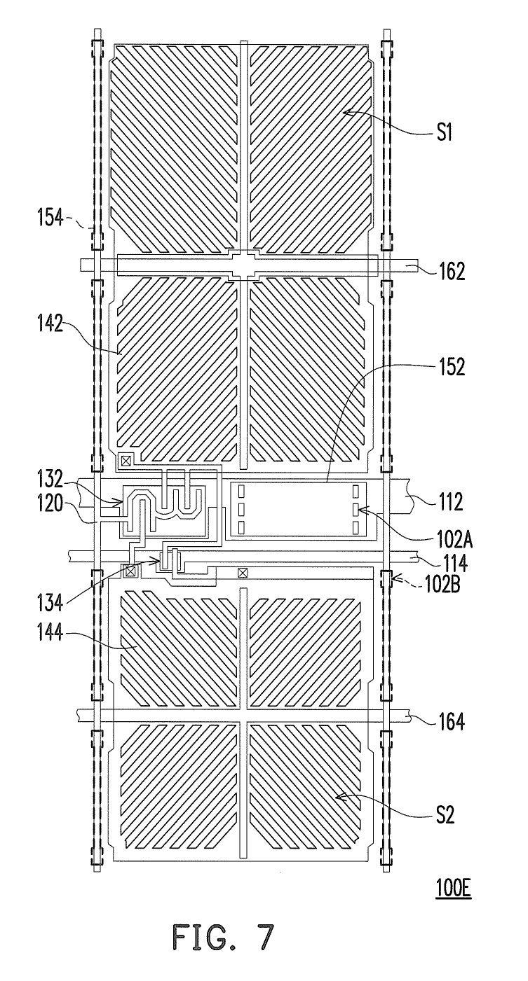

Certainly, the aforementioned pixel structures 100A-100D are only examples, which are not used to limit the design of the pixel structure of the invention. FIG. 7 is a top view of a pixel structure according to a fifth embodiment of the invention. Referring to FIG. 7, the pixel structure 100E includes the first scan line 112, a second scan line 114, the data line 120, the first active device 132, the first pixel electrode 142, a second active device 134, the second pixel electrode 144, the first conductive pattern 152 and the second conductive pattern 154. The second scan line 114 is parallel to the first scan line 112. The data line 120 is intersected to the first scan line 112 and the second scan line 114. The first active device 132 is connected to the first scan line 112 and the data line 120. The first pixel electrode 142 is electrically connected to the data line 120 through the first active device 132. The second active device 134 is connected to the second scan line 114 and the first pixel electrode 142. The second pixel electrode 144 is electrically connected to the data line 120 through the first active device 132, and is electrically connected to the first pixel electrode 142 through the second active device 134. The first conductive pattern 152 is located above the first scan line 112 and connected in parallel with the first scan line 112. The second conductive pattern 154 is located under the data line 120 and connected in parallel with the data line 120.

In detail, the pixel structure 100E of the present embodiment is similar to the pixel structure 100D of the fourth embodiment, though the pixel structure 100E further includes the second scan line 114 and the second active device 134. When a plurality of the pixel structures 100E is arranged in an array and is applied in a display panel (not shown), the second scan line 114 of each of the pixel structures 100E is, for example, connected to the first scan line 112 of the pixels structure 100E of a next row. Therefore, the second active device 134 is turned on when the pixel structure 100E of the next row is turned on, so that voltages of the first pixel electrode 142 and the second pixel electrode 144 are redistributed to achieve an ideal display quality. In this way, the first pixel electrode 142 and the second pixel electrode 144 may still present ideal display gray levels even being influenced by different capacitive coupling effects. Moreover, in the present embodiment, the design of dual conductive layers is also used to mitigate a negative influence of the impedances during signal transmission of the first scan line 112 and the data line 120.

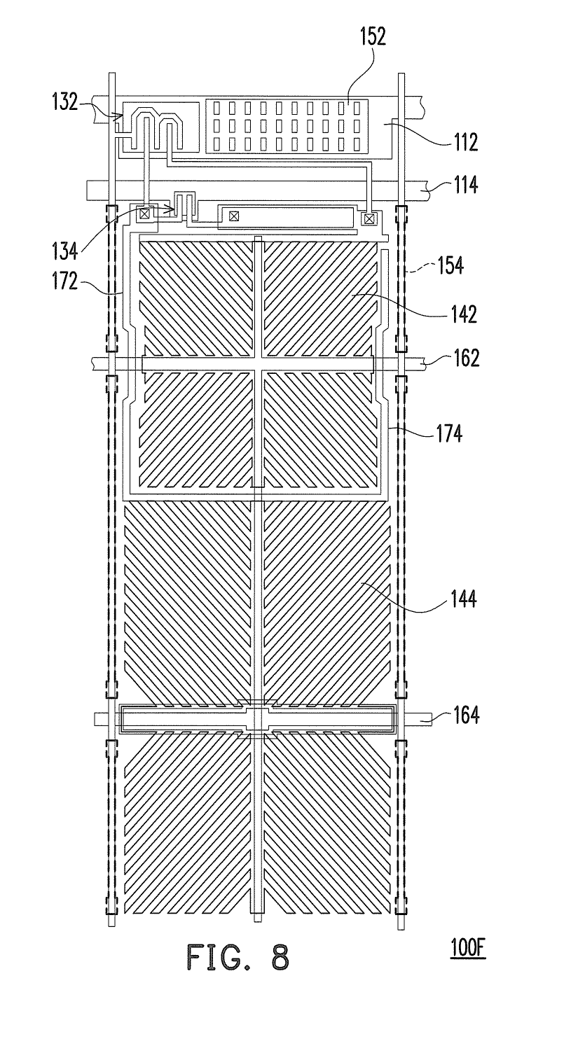

FIG. 8 is a top view of a pixel structure according to a sixth embodiment of the invention. Referring to FIG. 8, components of the pixel structure 100F are approximately the same to that of the aforementioned pixel structure 100E, which include the first scan line 112, the second scan line 114, the data line 120, the first active device 132, the first pixel electrode 142, the second active device 134, the second pixel electrode 144, the first conductive pattern 152 and the second conductive pattern 154. However, in the present embodiment, the first pixel electrode 142 of the pixel structure 100F is located between the second pixel electrode 144 and the second scan line 114, and the second scan line 114 is located between the first scan line 112 and the first pixel electrode 142.

Moreover, the pixel structure 100F further includes a connection pattern 172 and selectively includes an extension pattern 174. The connection pattern 172 and the extension pattern 174 are all protruded out from the second pixel electrode 144 and extended towards the second scan line 114, where the connection pattern 172 is further connected to the second active device 134 and the first active device 132. The connection pattern 172 and the extension pattern 174 are respectively located at one side of the first pixel electrode 142 closed to the connected data line 120, and another side of the first pixel electrode 142 departed from the connected data line 120. In other words, the connection pattern 172 and the extension pattern 174 are respectively located at two opposites sides of the first pixel electrode 142. In other embodiments, the connection pattern 172 can be selectively located at one side of the first pixel electrode 142 departed from the connected data line 120, and the extension pattern 174 can be selectively located at another side of the first pixel electrode 142 closed to the connected data line 120. In the present embodiment, the second pixel electrode 144, the connection pattern 172, and the extension pattern 174 approximately encircle three sides of the first pixel electrode 142 and expose a fourth side of the first pixel electrode 142, where the fourth side is adjacent to the second scan line 114.

In the present embodiment, the connection pattern 172 and the second pixel electrode 144 are a same film layer, and the extension pattern 174 and the second pixel electrode 144 are a same film layer. Configuration of the connection pattern 172 and the extension pattern 174 avails shielding the coupling effect to the first pixel electrode 142 produced by the data line 120, so as to improve the display quality of the pixel structure 100F. Moreover, none light shielding device is located between the first pixel electrode 142 and the second pixel electrode 144, which avails improving the display aperture ratio of the pixel structure 100F.

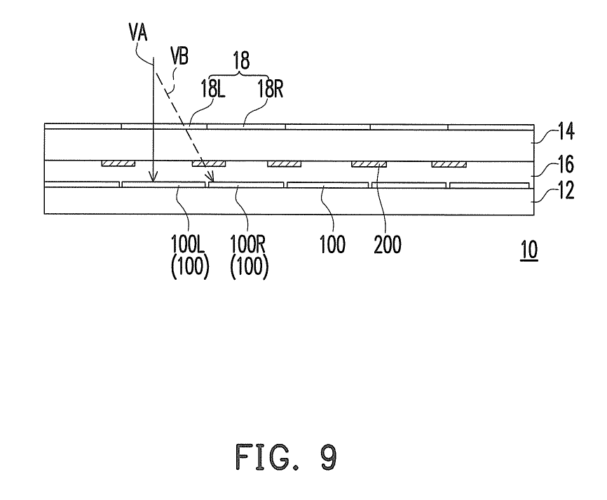

FIG. 9 is a cross-sectional view of a display panel according to an embodiment of the invention. Referring to FIG. 9, the display panel 10 includes a substrate 12, an opposite substrate 14, a display media layer 16 and a patterned retarder 18. In the present embodiment, the substrate 12 is disposed opposite to the opposite substrate 14, and the display media layer 16 is disposed between the substrate 12 and the opposite substrate 14. Moreover, the patterned retarder 18 is disposed on the opposite substrate 14 to implement a three-dimensional display effect of the display panel 10. Namely, when the patterned retarder 18 is configured, the display panel 10 is, for example, a three-dimensional display panel. Moreover, a plurality of pixel structures 100 is arranged in an array on the substrate 12, and the pixel structure 100 is, for example, selected from any one of the aforementioned pixel structures 100A-100F, so that the display media layer 16 can be driven by the pixel structures 100 to display desired images.

In detail, in case of the three-dimensional display, a part of the pixel structures 100, for example, a pixel structure 100L may display a left-eye image, and the other pixel structures, for example, a pixel structure 100R may display a right-eye image. The patterned retarder 18 has a plurality of retardation patterns 18L and 18R. The retardation patterns 18L and 18R respectively correspond to one of the pixel structures 100L and 100R, where the retardation patterns 18L and 18R respectively provide a specific retardation effect.

When an observer views the images displayed by the display panel 10, the observer may wear a pair of polarization glasses. The image displayed by the pixel structures 100 has a first polarization state after being processed by the retardation pattern 18L, and is observed by a left eye of the observer through a left lens of the polarization glasses. The image displayed by the pixel structures 100 has a second polarization state after being processed by the retardation pattern 18R, and is observed by a right eye of the observer through a right lens of the polarization glasses. In this way, the left eye and the right eye of the observer may receive different images to view a three-dimensional display image.

Generally, the pixel structure 100L is used for displaying the left-eye image, and the pixel structure 100R is used for displaying the right-eye image. When the observer views the image displayed by the display panel 10 from a viewing angle VA, the left-eye image displayed by the pixel structure 100L passes through the retardation pattern 18L, so that the left eye of the observer may only receive the left-eye image displayed by the pixel structure 100L. However, when the viewing angle VA of the observer is increased to a viewing angle VB, the right-eye image displayed by the pixel structure 100R may also pass through the retardation pattern 18L. Therefore, the left eye of the observer may receive the right-eye image displayed by the pixel structure 100R and cause a poor display effect (which is generally referred to as a cross talk phenomenon). Therefore, a specific light-shielding material is required to be disposed between the pixel structure 100L and the pixel structure 100R, for example, a black matrix pattern 200 disposed on one of the substrate 12 and the opposite substrate 14, so as to avoid the cross talk phenomenon. Moreover, the black matrix pattern 200 is varied as a design of the pixel structure varies.

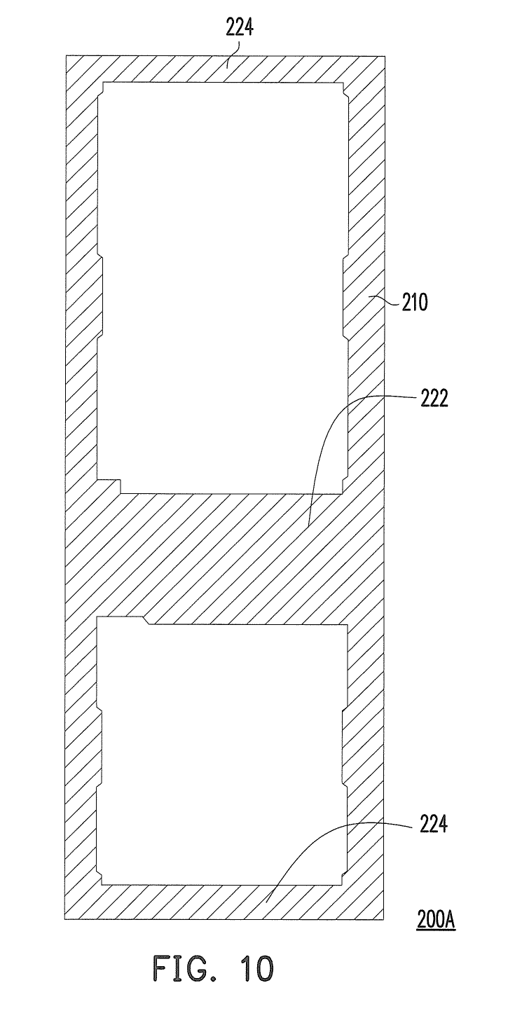

For example, FIG. 10 is a top view of a black matrix pattern according to an embodiment of the invention, which is used in collaboration with the pixel structure of FIG. 7. Referring to FIG. 7 and FIG. 10, the black matrix pattern 200A includes a vertical portion 210 and horizontal portions 222 and 224, and the black matrix pattern 200A may correspond to opaque components of the pixel structure 100E. In detail, the vertical portion 210 at least corresponds to the data line 120 of the pixel structure 100E, and the horizontal portion 222 corresponds to the first scan line 112 and the second scan line 114. Moreover, the horizontal portion 224 of the black matrix pattern 200A is further disposed at a boundary (which is, for example, a place between two adjacent pixel structures) of the pixel structure 100E. In this way, regarding the display panel 10 of FIG. 9, when the observer views along the viewing angle VB, the left eye of the observer cannot view the right-eye image displayed by the pixel structure 100R, so as to avoid the aforementioned cross talk phenomenon. It should be noticed that the black matrix pattern 200A can also be used in collaboration with the pixel structure 100D for applying in the display panel 10, so as to avoid the aforementioned cross talk phenomenon.

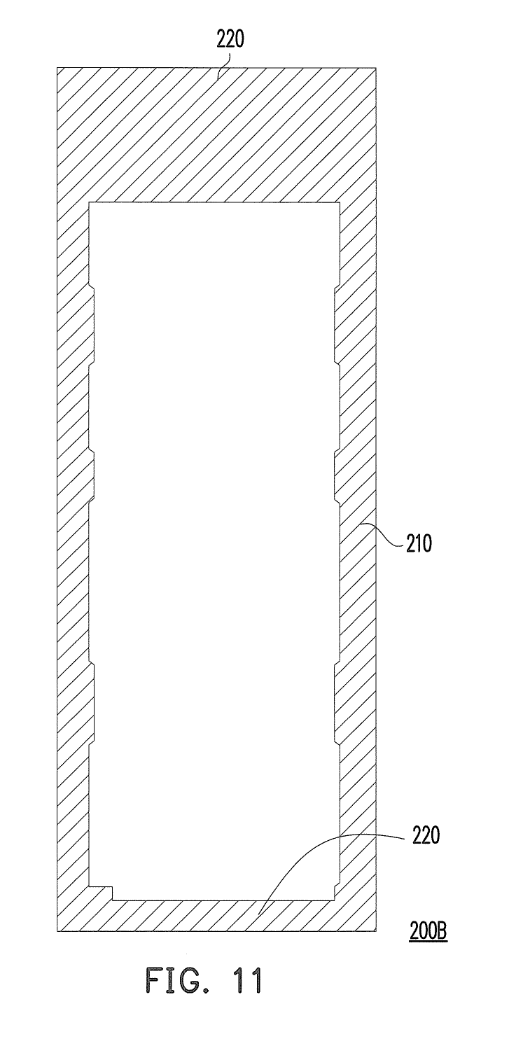

FIG. 11 is a top view of a black matrix pattern according to another embodiment of the invention, which is used in collaboration with the pixel structure of FIG. 8. Referring to FIG. 8 and FIG. 11, the black matrix pattern 200B includes the vertical portion 210 and a horizontal portion 220, and the black matrix pattern 200B may correspond to opaque components of the pixel structure 100F. In detail, the vertical portion 210 of the black matrix pattern 200B at least corresponds to the data line 120 of the pixel structure 100F, and the horizontal portion 220 corresponds to the first scan line 112 and the second scan line 114. Since the first scan line 112 and the second scan line 114 of the pixel structure 100F are located at a boundary of two pixel structures 100F, the black matrix pattern 200B does not require an additional horizontal portion 220. Therefore, when the black matrix pattern 200B is used in collaboration with the pixel structure 100F for applying in the display panel 10 of FIG. 9, the display panel 10 may have a high display aperture ratio. Moreover, the black matrix pattern 200B can also be used in collaboration with the pixel structures 100A-100C for applying in the display panel 10.

In summary, in the pixel structure of the invention, a design of connecting dual conductive layers in parallel is used to reduce the impedances the scan line and the data line. Therefore, the pixel structure and the display panel may have ideal signal transmission qualities. When a frame updating rate of the pixel structure or the display panel is increased, the pixel electrodes can still be written with voltages. Therefore, the display panel and the pixel structure can provide ideal display quality.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A pixel structure, comprising:
a first scan line;
a data line;
a first active device, connected to the first scan line and the data line;
a first pixel electrode, electrically connected to the data line through the first active device; and
a first conductive pattern, located above the first scan line and connected in parallel with the first scan line.

2. The pixel structure as claimed in claim 1, further comprising:
a second scan line;
a second active device, electrically connected to the second scan line and the first pixel electrode; and
a second pixel electrode, electrically connected to the data line through the first active device.

3. The pixel structure as claimed in claim 2, wherein the second pixel electrode is electrically connected to the first pixel electrode through the second active device.

4. The pixel structure as claimed in claim 2, further comprising a second conductive pattern located under the data line and connected in parallel with the data line, wherein the second conductive pattern and the first scan line are formed by a same film layer.

5. The pixel structure as claimed in claim 2, wherein the first conductive pattern and the data line are formed by a same film layer.

6. The pixel structure as claimed in claim 2, wherein the first scan line and the second scan line are located between the first pixel electrode and the second pixel electrode.

7. The pixel structure as claimed in claim 2, wherein the first pixel electrode is located between the second pixel electrode and the second scan line, and the second scan line is located between the first scan line and the first pixel electrode.

8. The pixel structure as claimed in claim 2, further comprising a connection pattern protruding from the second pixel electrode towards the second scan line to connect the second active device and the first active device.

9. The pixel structure as claimed in claim 8, wherein the connection pattern is located at one side of the first pixel electrode closed to the data line, or located at another side of the first pixel electrode departed from the data line.

10. The pixel structure as claimed in claim 8, wherein the connection pattern and the second pixel electrode are formed by a same film layer.

11. The pixel structure as claimed in claim 8, further comprising an extension pattern protruding from the second pixel electrode towards the second scan line, wherein the extension pattern and the connection pattern are respectively located at two opposite sides of the first pixel electrode, wherein the extension pattern and the second pixel electrode are formed by a same film layer.

12. The pixel structure as claimed in claim 2, further comprising a gate insulation layer covering the first scan line, the second scan line and the second conductive pattern, wherein the gate insulation layer has a plurality of first openings and a plurality of second openings, the first openings are located on the first scan line so that the first conductive pattern is connected in parallel with the first scan line through the first openings, and the second openings are located on the second conductive pattern so that the data line is connected in parallel with the second conductive pattern through the second openings.

13. The pixel structure as claimed in claim 2, wherein the second pixel electrode has a plurality of second slits to define a plurality of orientation directions.

14. The pixel structure as claimed in claim 1, wherein the first pixel electrode has a plurality of first slits to define a plurality of orientation directions.

15. The pixel structure as claimed in claim 1, wherein the first conductive pattern is substantially completely overlapped with the first scan line within a pixel region.

16. A pixel structure, comprising:
a first scan line;
a data line;
a first active device, connected to the first scan line and the data line;
a first pixel electrode, electrically connected to the data line through the first active device; and
a first conductive pattern, located under the data line and connected in parallel with the data line.

17. The pixel structure as claimed in claim 16, wherein the first conductive pattern is substantially completely overlapped with the data line within a pixel region.

18. A display panel, comprising:
a plurality of pixel structures, arranged on a substrate in an array, and each of the pixel structures comprising:
a first scan line;
a second scan line;
a data line;
a first active device, connected to the first scan line and the data line;
a first pixel electrode, electrically connected to the data line through the first active device;
a first conductive pattern, located above the first scan line and connected in parallel with the first scan line;
a second active device, electrically connected to the second scan line and the first pixel electrode; and
a second pixel electrode, electrically connected to the data line through the first active device, and the second scan line of each of the pixel structures being electrically connected to a first scan line of the pixel structure of a next row;
an opposite substrate, opposite to the substrate;
a display media layer, disposed between the substrate and the opposite substrate; and
a patterned retarder, disposed on the opposite substrate, and having a plurality of retardation patterns, wherein each of the retardation patterns corresponds to one of the pixel structures.

19. The display panel as claimed in claim 18, further comprising a black matrix pattern disposed on one of the substrate and the opposite substrate, wherein the black matrix pattern at least corresponds to the first scan line and the second scan line of each of the pixel structures.

20. The display panel as claimed in claim 19, wherein when the first scan line and the second scan line of each of the pixel structures are located between the first pixel electrode and the second pixel electrode, the black matrix pattern is located between two adjacent pixel structures.
